(19) United States
(12) Patent Application Publication
(10) Pub. No.: US 2013/0130732 A1
(43) Pub. Date: May 23, 2013

(54) SIGNAL SOURCE DEPLOYMENT SYSTEM, METHOD, AND NON-TRANSITORY TANGIBLE MACHINE-READABLE MEDIUM THEREOF

(71) Applicants: Shiann-Tsong Sheu, Taipei City (TW); Ming-Tse Kao, Taipei City (TW); Wen-Tsung Chang, Taipei City (TW); Yi-Hsuch Tsai, Taipei City (TW)

(72) Inventors: Shiann-Tsong Sheu, Taipei City (TW); Ming-Tse Kao, Taipei City (TW); Wen-Tsung Chang, Taipei City (TW); Yi-Hsuch Tsai, Taipei City (TW)

(21) Appl. No.: 13/312,266

(22) Filed: Dec. 6, 2011

(30) Foreign Application Priority Data
Nov. 18, 2011 (TW) 100142149

(51) Int. Cl. H04W 84/10

(52) U.S. Cl. 455/507

(57) ABSTRACT

A signal source deployment system, method, and non-transitory tangible machine-readable medium thereof are provided. The signal source deployment system comprises an electronic computing apparatus, wherein the electronic computing apparatus comprises a storage unit and a processor. The storage unit is electrically connected to the processor. The storage unit is configured to store a piece of plan information of a space and a piece of signal strength information of the space. The space is defined as a plurality of sub-spaces. The piece of signal strength information comprises a plurality of signal strength values. Each of the signal strength values corresponds to one of the sub-spaces. The processor determines a deployment position for a signal source according to the piece of plan information and the piece of signal strength information.

This application claims priority to Taiwan Patent Application No. 100142149 filed on Nov. 18, 2011.

### CROSS-REFERENCES TO RELATED APPLICATIONS

Not applicable.

### BACKGROUND OF THE INVENTION

1. Field of the Invention

The present invention relates to a signal source deployment system, a signal source deployment method, and a non-transitory tangible machine-readable medium thereof. More particularly, the present invention relates to a signal source deployment system, a signal source deployment method, and a non-transitory tangible machine-readable medium thereof that determines a deployment position of a signal source according to space-related information.

2. Descriptions of the Related Art

Owing to advancement of the science and technologies, applications and services of wireless network technologies are now developing towards the commercialized stage and become popularized gradually. However, services of nearly all kinds of wireless network technologies suffer from the problem of insufficient coverage because signals from signal sources for the wireless network services tend to be attenuated due to a long distance or the blocking effect of walls.

The most straightforward way of solving this problem is to deploy more signal sources. However, the number of signal sources deployed is limited due to considerations of the cost. Furthermore, due to limitations imposed by geographical conditions (e.g., how an indoor space is divided), an operator who is to deploy a wireless network environment (i.e., to deploy a signal source in a space) usually can only choose one of satisfying the signal coverage and satisfying stability of the connections as an evaluation criteria for deploying the signal source.

Currently, there is still no effective way available for the operator to determine a deployment position of the signal source. Operators usually deploy signal sources arbitrarily in the space. Consequently, the deployed wireless network environment has the following shortcomings: signal stability in the space can not be guaranteed (e.g., disconnections often take place) or to positions cannot be located definitely, and the received signal strength varies greatly among different positions in the space. Moreover, in order to make wireless network connections in the space stable, the operator must make tests on site for many times before a deployment position of the signal source can be determined, which is both labor- and time-consuming.

Accordingly, there is an urgent need for a technology of determining a deployment position of a signal source which can determine the deployment position in an efficient way and can ensure both requirements of signal coverage and signal stability.

### SUMMARY OF THE INVENTION

An objective of the present invention is to provide a signal source deployment system, which comprises an electronic computing apparatus. The electronic computing apparatus comprises a storage unit and a processor electrically connected with each other. The storage unit is configured to store a piece of plan information of a space and a piece of signal strength information of the space. The space is defined as a plurality of sub-spaces. The piece of signal strength information comprises a plurality of signal strength values, and each of the signal strength values corresponds to one of the sub-spaces. The processor is configured to determine a deployment position of a signal source according to the piece of plan information and the piece of signal strength information.

Another objective of the present invention is to provide a signal source deployment method for an electronic apparatus. The signal source deployment method comprises the following steps of: (a) enabling the electronic apparatus to receive a piece of plan information of a space; (b) enabling the electronic apparatus to receive a piece of signal strength information of the space, wherein the space is defined as a plurality of sub-spaces, the piece of signal strength information comprises a plurality of signal strength values, and each of the signal strength values corresponds to one of the sub-spaces; and (c) enabling the electronic apparatus to determine a first deployment position of a first signal source according to the piece of plan information and the piece of signal strength information.

Yet a further objective of the present invention is to provide a non-transitory tangible machine-readable medium storing a program. When the program is loaded into an electronic apparatus, a plurality of codes comprised in the program is executed by the electronic apparatus to accomplish the aforesaid signal source deployment method.

According to the above descriptions, the signal source deployment system, the signal source deployment method, and the non-transitory tangible machine-readable medium thereof of the present invention determine the most appropriate deployment position of the signal source according to various environmental information (such as the piece of plan information and the piece of signal strength information) of the space. Thereby, the present invention can overcome the problems of instable signal quality and significant differences in signal strength in the space caused by the conventional signal source deployment approach.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view of a signal source deployment system 1 according to a first embodiment of the present invention;

FIG. 1B is a schematic view of the piece of plan information in the first embodiment of the present invention;

FIG. 1C is a schematic view illustrating distribution of signals in the first embodiment of the present invention;

FIG. 2 is a schematic view of a signal source deployment system 2 according to a second embodiment of the present invention;

FIG. 3 is a schematic view of a signal source deployment system 3 according to a third embodiment of the present invention;

FIG. 4 is a schematic view of a signal source deployment system 4 according to a fourth embodiment of the present invention; and

FIG. 5A and FIG. 5B are schematic flowchart diagrams of a signal source deployment method according to the present invention.

### DESCRIPTION OF THE PREFERRED EMBODIMENT

In the following description, the signal source deployment system, the signal source deployment method and the non-transitory tangible machine-readable medium thereof according to the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction.

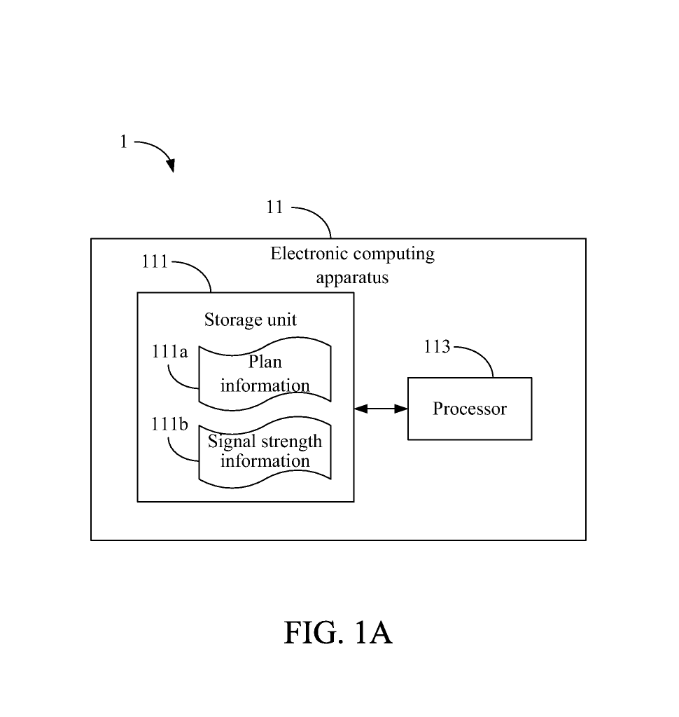

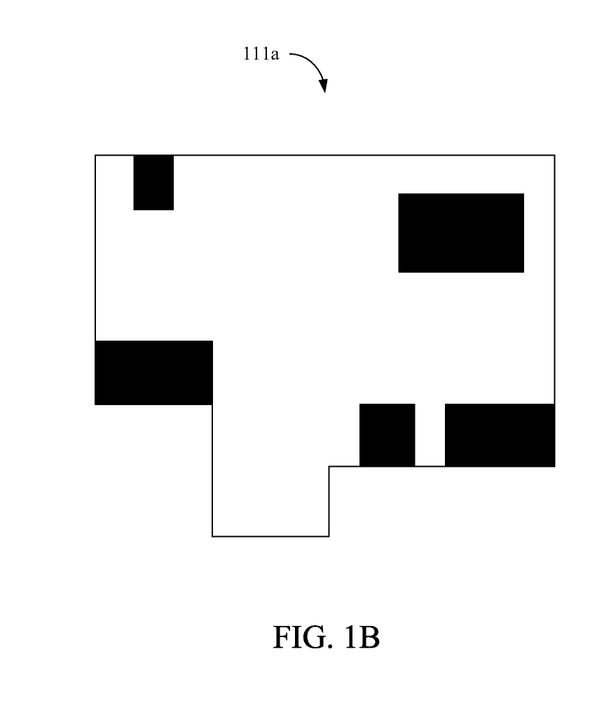

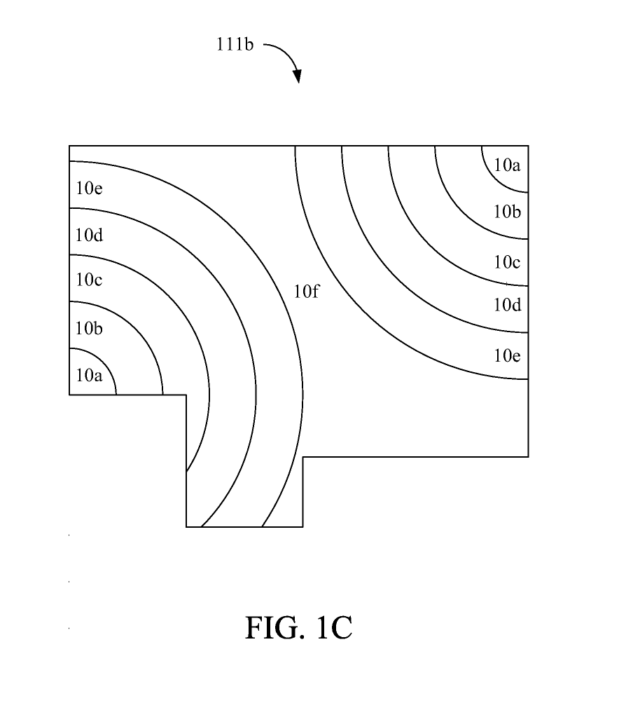

A first embodiment of the present invention is a signal source deployment system 1, a schematic view of which is depicted in FIG. 1A. The signal source deployment system 1 can determine a deployment position of a signal source in a space having boundaries (e.g., an indoor space). The signal source may be a base station, a wireless network access point, a femtocell, or any device capable of providing wireless network services.

The signal source deployment system 1 comprises an electronic computing apparatus 11, and the electronic computing apparatus 11 comprises a storage unit 111 and a processor 113 electrically connected with each other. The electronic computing apparatus 11 may be a server, a desktop computer, a notebook computer or any device having a computing capability and well known to those of ordinary skill in the art. The storage unit 111 may be a memory, a floppy disk, a hard disk, a compact disk (CD), a mobile disk, a magnetic tape, a database, or any other storage media with the same function and well known to those skilled in the art. The processor 113 may be any of various processors, central processing units (CPUs), microprocessors or other processing devices well known to those of ordinary skill in the art.

The storage unit 111 stores a piece of plan information 111a of the space and a piece of signal strength information 111b of the space. The piece of plan information 111a is used to let the processor 113 know where there is an obstacle (e.g., an office desk, a chair, etc) and where there is no obstacle. Even more, the processor 113 is able to know the type and spatial information (e.g., a height of the obstacle) of the obstacle from the piece of plan information 111a. In the subsequent processing process, the processor 113 can determine positions in the space that a signal source can be deployed and the positions in the space that a signal source cannot be deployed according to the piece of plan information 111a, and then choose an appropriate position as a deployment position of the signal source. In the present invention, the form of the piece of plan information 111a is not limited as long as it records positions where there is no obstacle and where there is an obstacle in the space. For example, the piece of plan information 111a may be a plan arrangement view as shown in FIG. 1B or relative coordinate information of objects disposed in the space. In FIG. 1B, each black block represents a position where there is an obstacle in the space.

The piece of signal strength information 111b is used to let the processor 113 know signal strength values of individual positions in the space. Specifically, the space is defined as a plurality of sub-spaces and the piece of signal strength information 111b comprises a plurality of signal strength values, wherein each of the signal strength values corresponds to one of the sub-spaces. For example, if the space is an office space, then different seats correspond to different signal strength values. It shall be appreciated that the form of the piece of signal strength information 111b is not limited in the present invention as long as it records signal strength values in the space. In this embodiment, the signal distribution graph depicted in FIG. 1C is used as the piece of signal strength information 111b. In detail, the signal strength values are divided into six levels in this embodiment, namely, a strong level, a slightly strong level, a middle level, a slightly weak level, a weak level, and a zero level. In FIG. 1C, regions 10a correspond to a “strong” signal strength value, regions 10b correspond to a “slightly strong” signal strength value, regions 10c correspond to a “middle” signal strength value, regions 10d correspond to a “slightly weak” signal strength value, regions 10e correspond to a “weak” signal strength value, and the region 10f corresponds to a “zero” signal strength value.

Then, the processor 113 can adopt various strategies to determine a deployment position of a signal source according to the piece of plan information 111a and the piece of signal strength information 111b. For example, a strategy adopted by the processor 113 is to arrange the deployment position of the signal source at a position where the signal strength is the weakest in the space. When this strategy is adopted, the piece of plan information 111a may be firstly defined as a plurality of deployable regions (e.g., the white region in FIG. 1B may be defined as a plurality of deployable regions). Afterwards, the processor 113 chooses one of the deployable regions that corresponds to a minimum signal strength value as the deployment position of the signal source. As another example, the processor 113 may also arrange the deployment position of the signal source at a position where a stable signal is in an urgent need in the space according to the piece of plan information 111a and the piece of signal strength information 111b. Briefly speaking, the processor 113 can adopt different strategies to determine the deployment position of the signal source according to the piece of plan information 111a and the piece of signal strength information 111b.

According to the above descriptions, the signal source deployment system 1 of the first embodiment takes the piece of plan information 111a and the piece of signal strength information 111b into consideration when determining the deployment position of the signal source, so the problems of instable signal quality and significant differences in signal strength in the space caused by the conventional signal source deployment approach can be eliminated.

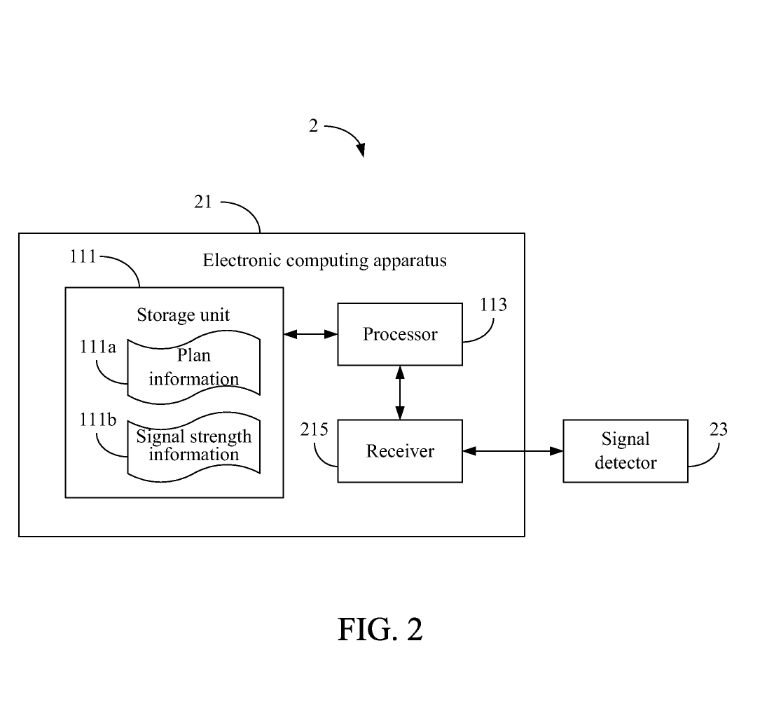

A second embodiment of the present invention is a signal source deployment system 2, a schematic view of which is depicted in FIG. 2. The signal source deployment system 2 comprises an electronic computing apparatus 21 and a signal detector 23. The electronic computing apparatus 21 comprises a storage unit 111, a processor 113, and a receiver 215. The processor 113 is electrically connected to the storage unit 111 and the receiver 215. The signal source deployment system 2 is suitable for a space having boundaries, and the storage unit 111 stores a piece of plan information 111a of the space and a piece of signal strength information 111b of the space.

The signal source deployment system 2 of the second embodiment can execute operations of the signal source deployment system 1 of the first embodiment. In addition, the signal source deployment system 2 has the functions that the signal source deployment system 1 has. Therefore, only the differences between the signal source deployment system 2 and the signal source deployment system 1 are detailed hereinbelow.

The signal source deployment system 2 is able to determine deployment positions of a plurality of signal sources. Firstly, the signal source deployment system 2 may determine a first deployment position of the first signal source in the same way as the signal source deployment system 1.

After the first signal source is disposed at the first deployment position, the signal detector 23 moves in the space (e.g., a user holding the signal detector 23 moves in the space, or the signal detector 23 moves by itself in the space). During the moving process, the signal detector 23 sends a request signal to the first signal source and receives a corresponding response signals transmitted by the first signal source at different positions. In this way, the signal detector 23 can obtain signal strength values of the first signal source on the sub-spaces defined in the space.

For each signal strength value, the signal detector 23 generates a corresponding first signal strength value. For example, each first signal strength value may be identical to its corresponding signal strength value. As another example, the signal detector 23 can divide the signal strength values into different levels and takes a level corresponding to the signal strength value as the first signal strength value. Therefore, each of the first signal strength values may be regarded as a signal strength value of the first signal source on one of the sub-spaces as well. Thereafter, the signal detector 23 transmits the first signal strength values to the receiver 215 and the receiver 215 receives the first signal strength values transmitted by the signal detector 23.

The processor 113 then updates the signal strength values comprised in the piece of signal strength information 111b according to the first signal strength values received by the receiver 215. Then, the processor 113 can determine a second deployment position of a second signal source according to the piece of plan information 111a and the piece of updated signal strength information 111b. Hereinbelow, an exemplary example will be described to explain how the processor 113 determines the second deployment position of the second signal source according to the piece of plan information 111a and the piece of updated signal strength information 111b. However, this exemplary example is not intended to limit the scope of the present invention.

The piece of plan information 111a may be firstly defined as a plurality of deployable regions. For each of the deployable regions, the signal source deployment system 2 executes the following operations:

(a) After the second signal source is disposed in the deployable region, the signal detector 23 moves in the space. During the moving process, the signal detector 23 sends a request signal to the second signal source and receives a corresponding response signal transmitted by the second signal source at different positions. In this way, the signal detector 23 can obtain the signal strength values of the second signal source on the sub-spaces defined in the space when the second signal source is disposed in the deployment region.

(b) For each signal strength value, the signal detector 23 generates a corresponding second signal strength value. For example, each second signal strength value may be identical to its corresponding signal strength value. As another example, the signal detector 23 can divide the signal strength values into different levels and takes a level corresponding to the signal strength value as the second signal strength value. Therefore, each of the second signal strength values may be regarded as the signal strength value of the second signal source on one of the sub-spaces as well when the second signal source is disposed in the deployable region. Thereafter, the signal detector 23 transmits the second signal strength values to the receiver 215.

(c) The receiver 215 receives these second signal strength values transmitted by the signal detector 23. Then, the processor 113 temporarily updates the signal strength values comprised in the piece of signal strength information 111b according to the second signal strength values, and calculates a statistic amount of signal strength values that are smaller than a threshold among these updated signal strength values. The threshold may be regarded as a basis requirement on signal strength; and if a signal strength value is smaller than the threshold, it means that the signal strength fails to comply with the basis requirement.

After the aforesaid operations (a) to (c) have been completed for each of the deployable regions, a plurality of statistic amounts are obtained by the processor 113. The processor 113 then chooses the deployable region that corresponds to the smallest statistic amounts as the second deployment position of the second signal source. In other words, when the second signal source is disposed at the second deployment position, the signal strength values in the space can be improved most. If more than two signal sources are to be deployed in the space, then the signal source deployment system 2 can proceed to determine deployment positions of other signal sources by repeating the aforesaid operations of determining the second deployment position of the second signal source.

It shall be appreciated that, the terms “first” and “second” used in the terms “the first signal source” and “the second signal source” are only intended to distinguish the first signal source and the second signal source from each other. Similarly, the terms “first” and “second” used in the terms “the first deployment position” and “the second deployment position” are only intended to distinguish the first deployment position and the second deployment position from each other.

In this embodiment, the storage unit 111 has already stored the piece of signal strength information 111b at the initial stage. However, in other embodiments, the signal source deployment system 2 may collect a plurality of initial signal strength values by the signal detector 23 and then generate the piece of signal strength information 111b according to the initial signal strength values. For example, the detector 23 may move in the space. During the moving process, the signal detector 23 sends a request signal to ambient signal source(s) in the space and receives corresponding response signal(s) at different positions. In this way, a plurality of initial signal strength values can be obtained by the signal detector 23. For each of these initial signal strength values, the signal detector 23 may generate an identical signal strength value, or divide the initial signal strength values into different levels and take a level of the initial signal strength as a signal strength value. Thereafter, these signal strength values are received by the receiver 215 from the signal detector 23 and stored by the processor 113 into the storage unit 111 as the piece of signal strength information 111b.

According to the above descriptions, the electronic computing apparatus 21 of the signal source deployment system 2 takes the piece of stored plan information 111a and the piece of signal strength information 111b updated in each stage into consideration when determining the deployment positions of the signal sources, so the problems of instable signal quality and significant differences in signal strength in the space caused by the conventional signal source deployment approach can be eliminated.

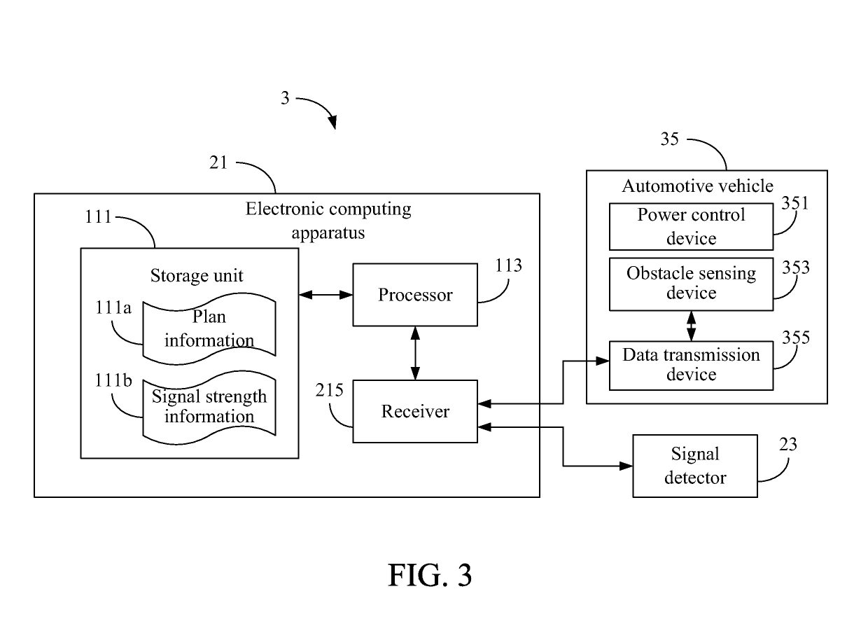

A third embodiment of the present invention is a signal source deployment system 3, a schematic view of which is depicted in FIG. 3. The signal source deployment system 3 comprises an electronic computing apparatus 21, a signal detector 23, and an automotive vehicle 35. The automotive vehicle 35 comprises a power control device 351, an obstacle sensing device 353, and a data transmission device 355. The electronic computing apparatus 21 and the signal detector 23 comprised in the signal source deployment system 3 are the same as the electronic computing apparatus 21 and the signal detector 23 comprised in the signal source deployment system 2 of the second embodiment, respectively.

The signal source deployment system 3 of the third embodiment can execute operations of the signal source deployment system 2 of the second embodiment, and has functions of the signal source deployment system 2. Therefore, only the differences between the signal source deployment system 3 of the third embodiment and the signal source deployment system 2 of the second embodiment are described below.

Before determining a deployment position of each of the signal sources, the automotive vehicle 35 moves in the space and collects data related to spatial arrangement so that the electronic computing apparatus 21 generates the piece of plan information 111a according to the data. Specifically, the power control apparatus 351 can control the automotive vehicle 35 to move in the space. As the automotive vehicle 35 moves in the space, the obstacle sensing device 353 senses obstacles to obtain spatial data related to the spatial arrangement. The spatial data sensed is then transmitted by the data transmission apparatus 355 to the receiver 215, and the receiver 215 receives the spatial data from the data transmission device 335. Then, the processor 113 can process the spatial data to obtain the piece of plan information 111a and stores the piece of plan information 111a into the storage unit 111. It shall be appreciated that the present invention has no limitation on how the piece of plan information 111a is generated according to the spatial data collected.

After the piece of plan information 111a is generated and stored, the signal source deployment system 3 can determine deployment positions of a plurality of signal sources in the same way as the signal source deployment system 2.

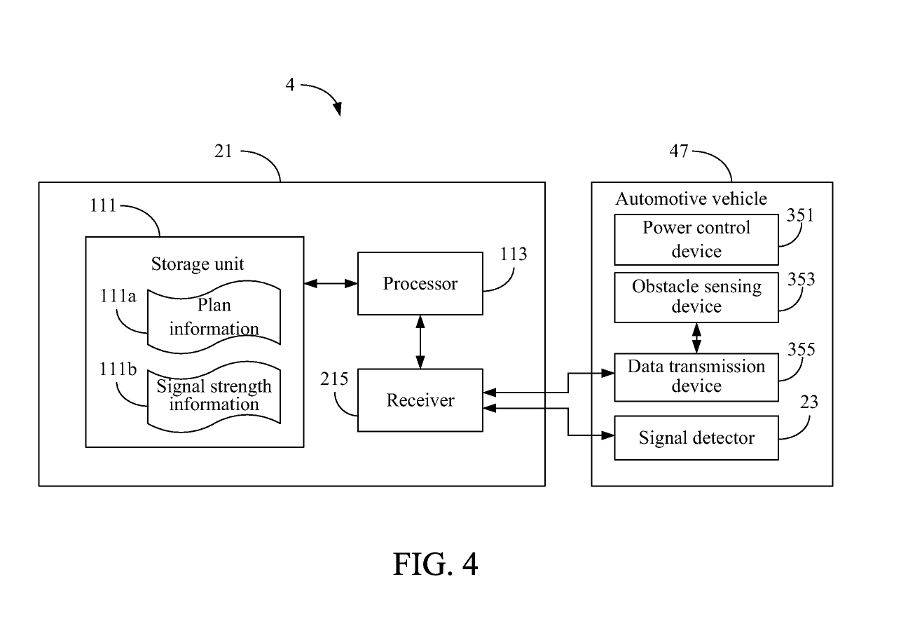

A fourth embodiment of the present invention is a signal source deployment system 4, a schematic view of which is depicted in FIG. 4. The signal source deployment system 4 comprises an electronic computing apparatus 21 and an automotive vehicle 47. The electronic computing apparatus 21 comprised in the signal source deployment system 4 is the same as the electronic computing apparatuses 21 comprised in the signal source deployment systems 2 and 3 of the second and the third embodiments. The automotive vehicle 47 comprises a power control device 351, an obstacle sensing device 353, a data transmission device 355, and a signal detector 23.

The signal source deployment system 4 differs from the signal source deployment system 3 only in the position where the signal detector 23 is disposed. Specifically, the automotive vehicle 47 of the signal source deployment system 4 has the signal detector 23 integrated therein.

Aside from the aforesaid differences, the signal source deployment system 4 of the fourth embodiment can execute operations of the signal source deployment system 3 of the third embodiment, and has functions of the signal source deployment system 3. Therefore, no further description will be made on the signal source deployment system 4 herein.

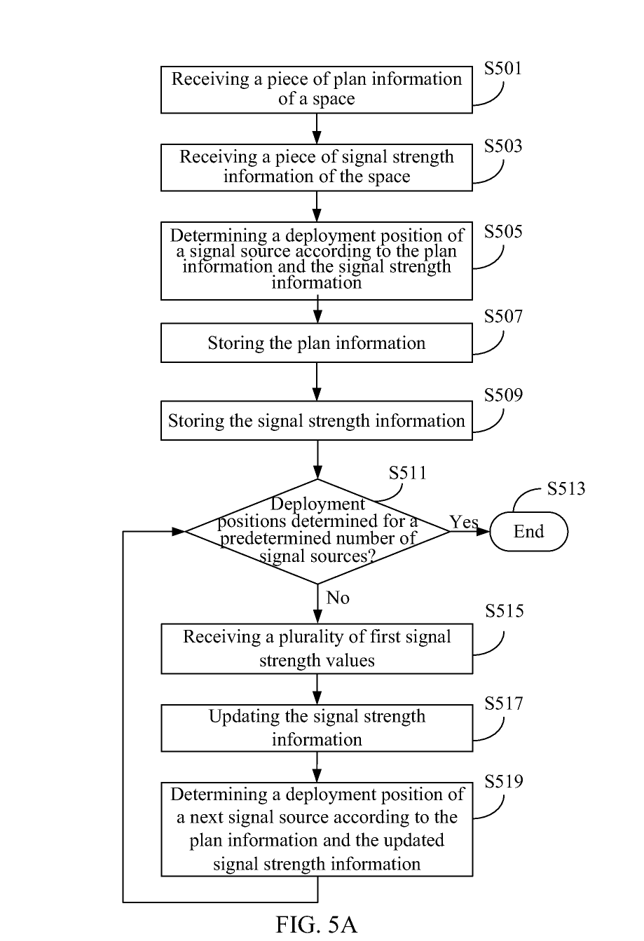

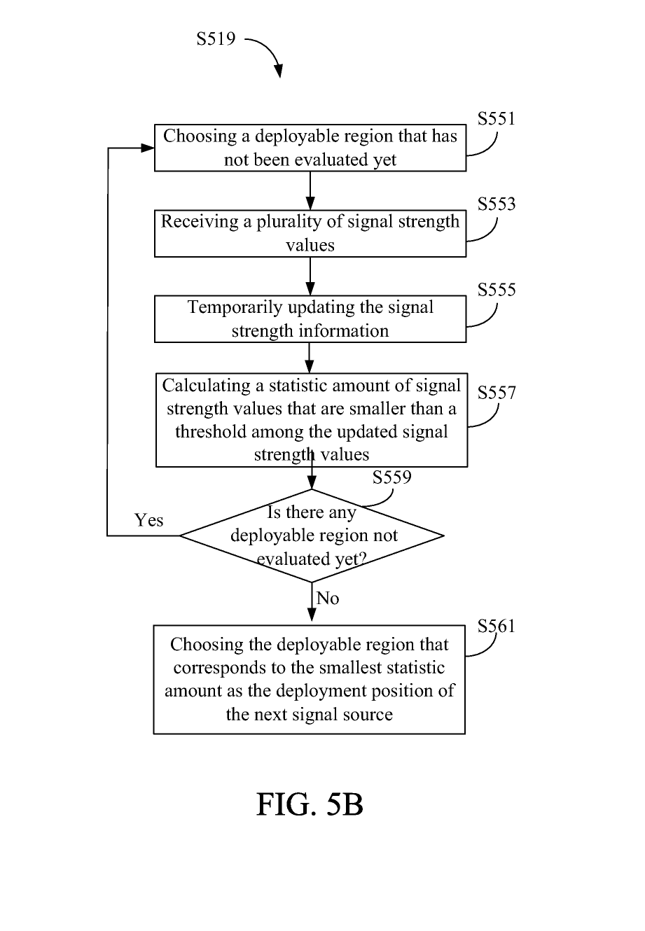

A fifth embodiment of the present invention is a signal source deployment method, a flowchart of which is depicted in FIG. 5A and FIG. 5B. The signal source deployment method is suitable for an electronic apparatus, e.g., each of the signal source deployment systems 1, 2, 3, and 4 of the first, the second, the third and the fourth embodiment. When the electronic apparatus is placed in a space having boundaries (e.g., an indoor space), a deployment position of at least one signal source can be determined by the signal source deployment method.

Firstly, step S501 is executed to enable the electronic apparatus to receive a piece of plan information of the space. Then, step S503 is executed to enable the electronic apparatus to receive a piece of signal strength information of the space. It shall be appreciated that the space is defined as a plurality of sub-spaces, the piece of signal strength information comprises a plurality of signal strength values, and each of the signal strength values corresponds to one of the sub-spaces. In other embodiments, the execution order of the steps S501 and S503 can be changed or the two steps can be executed simultaneously.

Next, step S505 is executed to enable the electronic apparatus to determine a first deployment position of a first signal source according to the piece of plan information and the piece of signal strength information. For example, in the step S505, the electronic apparatus may be enabled to choose a deployable region from a plurality of deployable regions defined in the piece of plan information as the first deployment position of the first signal source, wherein the chosen deployable region is the one that corresponds to a minimum signal strength value. Alternatively, in the step S505, the electronic apparatus may be enabled to choose the deployable region that requires a stable signal at most as the first deployment position of the first signal source. Then, the first signal source can be disposed at the first deployment position.

If the electronic device comprises a storage unit, then the signal source deployment method may further execute step S507 to enable the electronic apparatus to store the piece of plan information and execute step S509 to enable the electronic apparatus to store the piece of signal strength information. It shall be appreciated that, the execution orders of the steps S507 and S509 are not limited in the present invention as long as the step S507 is executed after the step S501 and the step S509 is executed after the step S503.

Next, step S511 is executed to determine whether deployment positions have been determined for a predetermined number of signal sources. If the answer is “yes,” then step S513 is executed to end the signal source deployment method. Otherwise, if the answer is “no,” then step S515 is executed to enable the electronic apparatus to receive a plurality of first signal strength values after the first signal source is disposed at the first deployment position. It is noted that each of the first signal strength values is a signal strength value of the first signal source on one of the sub-spaces. Step S517 is executed to enable the electronic apparatus to update the signal strength values comprised in the piece of signal strength information according to the first signal strength values. Afterwards, step S519 is executed to enable the electronic apparatus to determine a deployment position of a next signal source according to the piece of plan information and the piece of updated signal strength information. If the first deployment position is determined in the previous loop, then the second deployment position of the second signal source will be determined in the step S519 in the current loop.

Specifically, the step S519 may be accomplished according to the flowchart diagram depicted in FIG. 5B. As described above, the piece of plan information defines a plurality of deployable regions. Step S551 is executed to enable the electronic apparatus to choose a deployable region that has not been evaluated yet. Then, step S553 is executed to enable the electronic apparatus to receive a plurality of signal strength values, wherein each of the signal strength values is a signal strength value of a next signal source on one of the sub-spaces when the next signal source is disposed in the corresponding deployable region. Subsequently, step S555 is executed to enable the electronic apparatus to temporarily update the signal strength values comprised in the piece of signal strength information according to the signal strength values received in the step S553. Next, step S557 is executed to calculate a statistic amount of signal strength values that are smaller than a threshold among the updated signal strength values.

Step S559 is executed to enable the electronic apparatus to determine if there is still any deployable region that has not been evaluated yet. If the answer is “yes,” then the steps S551 to S557 are repeated. If the answer is “no,” then step S561 is executed to enable the electronic apparatus to choose the deployable region that corresponds to the smallest statistic amount as the deployment position of the next signal source.

If the electronic apparatus comprises a signal detector, then a detection step may be further executed before the step S503 to obtain the signal strength values comprised in the piece of signal strength information. Additionally, another detection step may also be executed before the step S553 to obtain signal strength values for evaluation.

Furthermore, if the electronic apparatus comprises an automotive vehicle, then a sensing step and a processing step may be executed before the step S503. The sensing step is to enable the electronic apparatus to sense obstacles so as to obtain a plurality of spatial data as the automotive vehicle moves in the space, while the processing step is to enable the electronic apparatus to obtain the piece of plan information by processing the spatial information.

In addition to the aforesaid steps, the signal source deployment method of the fifth embodiment can also execute all the operations and functions set forth in the first to the fourth embodiments. How the fifth embodiment executes these operations and functions will be readily appreciated by those of ordinary skill in the art based on the explanation of the first to the fourth embodiments, and thus will not be further described herein.

As can be known from what described above, the signal source deployment method of the fifth embodiment takes the piece of plan information and the piece of signal strength information of the space into consideration when determining a deployment position of a signal source, so the problems of instable signal quality and significant differences in signal strength in the space caused by the conventional signal source deployment approach can be eliminated.

The signal source deployment method of the fifth embodiment may be implemented by a program which is stored in a non-transitory tangible machine-readable medium. When the program is loaded into an electronic apparatus, a plurality of codes comprised in the program will be executed by the electronic apparatus to accomplish all the steps described in the fifth embodiment. This non-transitory tangible machine-readable medium may be a common electronic device, such as a read only memory (ROM), a flash memory, a floppy disk, a hard disk, a compact disk (CD), a mobile disk, a magnetic tape, a database accessible to networks, or any other storage media with the same function and well known to those skilled in the art.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A signal source deployment system, comprising:
an electronic computing apparatus, comprising:
a storage unit, being configured to store a piece of plan information of a space and a piece of signal strength information of the space, wherein the space is defined as a plurality of sub-spaces, the piece of signal strength information comprises a plurality of signal strength values, and each of the signal strength values corresponds to one of the sub-spaces; and
a processor, being electrically connected to the storage unit and configured to determine a first deployment position of a first signal source according to the piece of plan information and the piece of signal strength information.

2. The signal source deployment system as claimed in claim 1, wherein the piece of plan information defines a plurality of deployable regions, and the processor chooses one of the deployable regions that corresponds to a minimum signal strength value as the first deployment position.

3. The signal source deployment system as claimed in claim 1, wherein the first signal source is disposed at the first deployment position, and the electronic computing apparatus further comprises:
a receiver, being configured to receive a plurality of first signal strength values, each of the first signal strength values being a signal strength value of the first signal source on one of the sub-spaces,
wherein the processor is further configured to update the signal strength values comprised in the piece of signal strength information according to the first signal strength values and the processor is further configured to determine a second deployment position of a second signal source according to the piece of plan information and the piece of updated signal strength information.

4. The signal source deployment system as claimed in claim 3, wherein the piece of plan information defines a plurality of deployable regions, the receiver is further configured to receive a plurality of second signal strength values for each of the deployable regions, each of the second signal strength values is a signal strength value of a second signal source on one of the sub-spaces when the second signal source is disposed in the corresponding deployable region, and the processor is further configured to execute the following operations:
updating the signal strength values comprised in the piece of signal strength information according to the second signal strength values temporarily, and
calculating a statistic amount of signal strength values that are smaller than a threshold among the updated signal strength values,
wherein the processor is further configured to choose the deployable region that corresponds to the smallest statistic amount as the second deployment position.

5. The signal source deployment system as claimed in claim 1, wherein the first signal source is one of a base station, a wireless network access point, and a femtocell.

6. The signal source deployment system as claimed in claim 1, further comprising:
at least one signal detector, being configured to detect the signal strength values in the space.

7. The signal source deployment system as claimed in claim 1, further comprising:
an automotive vehicle, comprising:
a power control device, being configured to control the automotive vehicle to move in the space;
an obstacle sensing device, being configured to sense obstacles when the automotive vehicle moves in the space so as to obtain a plurality of spatial data; and
a data transmission device, being configured to transmit the spatial data;
wherein the electronic computing device further comprises a receiver electrically connected to the processor and configured to receive the spatial data from the data transmission device, and the processor is further configured to process the spatial data to obtain the piece of plan information.

8. The signal source deployment system as claimed in claim 7, wherein the automotive vehicle further comprises:
at least one signal detector, being configured to detect the signal strength values in the space;
wherein the data transmission device is further configured to transmit the signal strength values, and the receiver is further configured to receive the signal strength values from the data transmission device.

9. A signal source deployment method for use in an electronic apparatus, comprising the following steps of:
(a) enabling the electronic apparatus to receive a piece of plan information of a space;
(b) enabling the electronic apparatus to receive a piece of signal strength information of the space, wherein the piece of signal strength information comprises a plurality of signal strength values, the space is defined as a plurality of sub-spaces, and each of the signal strength values corresponds to one of the sub-spaces; and
(c) enabling the electronic apparatus to determine a first deployment position of a first signal source according to the piece of plan information and the piece of signal strength information.

10. The signal source deployment method as claimed in claim 9, further comprising the following steps of:
enabling the electronic apparatus to store the piece of plan information; and
enabling the electronic apparatus to store the piece of signal strength information.

11. The signal source deployment method as claimed in claim 9, wherein the piece of plan information defines a plurality of deployable regions and the step (c) enables the electronic apparatus to choose one of the deployable regions that corresponds to a minimum signal strength value as the first deployment position.

12. The signal source deployment method as claimed in claim 9, wherein the first signal source is disposed at the first deployment position and the signal source deployment method further comprises the following steps of:
(d) enabling the electronic apparatus to receive a plurality of first signal strength values, each of the first signal strength values being a signal strength value of the first signal source on one of the sub-spaces;
(e) enabling the electronic apparatus to update the signal strength values comprised in the piece of signal strength information according to the first signal strength values; and
(f) enabling the electronic apparatus to determine a second deployment position of a second signal source according to the piece of plan information and the piece of updated signal strength information.

13. The signal source deployment method as claimed in claim 12, wherein the piece of plan information defines a plurality of deployable regions and the step (f) further comprises the following steps of:
(f1) enabling the electronic apparatus to execute the following steps for each of the deployable regions:
receiving a plurality of second signal strength values, wherein each of the second signal strength values is a signal strength value of a second signal source on one of the sub-spaces when the second signal source is disposed in the deployable region;
updating the signal strength values comprised in the piece of signal strength information according to the second signal strength values temporarily, and
calculating a statistic amount of signal strength values that are smaller than a threshold among the updated signal strength values; and
(f2) enabling the electronic apparatus to choose the deployable region that corresponds to the smallest statistic amount as the second deployment position.

14. The signal source deployment method as claimed in claim 9, further comprising the following steps:
enabling the electronic apparatus to detect the signal strength values in the space.

15. The signal source deployment method as claimed in claim 9, further comprising the following steps:
enabling the electronic apparatus to sense obstacles when moving in the space so as to obtain a plurality of spatial data; and
enabling the electronic apparatus to obtain the piece of plan information by processing the spatial data.

16. A non-transitory tangible machine-readable medium, being stored with a computer program, the computer program comprising a plurality of codes, the codes being able to execute a signal source deployment method when the computer program is loaded into an electronic apparatus, the codes comprising:
code A for enabling the electronic apparatus to receive a piece of plan information of a space, wherein the space is defined as a plurality of sub-spaces;
code B for enabling the electronic apparatus to receive a piece of signal strength information of the space, wherein the piece of signal strength information comprises a plurality of signal strength values, and each of the signal strength values corresponds to one of the sub-spaces; and
code C for enabling the electronic apparatus to determine a first deployment position of a first signal source according to the piece of plan information and the piece of signal strength information.

17. The non-transitory tangible machine-readable medium as claimed in claim 16, wherein the codes further comprise:
code D for enabling the electronic apparatus to store the piece of plan information; and
code E for enabling the electronic apparatus to store the piece of signal strength information.

18. The non-transitory tangible machine-readable medium as claimed in claim 16, wherein the piece of plan information defines a plurality of deployable regions and the code C enables the electronic apparatus to choose one of the deployable regions that corresponds to a minimum signal strength value as the first deployment position.

19. The non-transitory tangible machine-readable medium as claimed in claim 16, wherein the first signal source is disposed at the first deployment position and the codes further comprise:
code D for enabling the electronic apparatus to receive a plurality of first signal strength values, each of the first signal strength values is a signal strength value of the first signal source on one of the sub-spaces;
code E for enabling the electronic apparatus to update the signal strength values comprised in the piece of signal strength information according to the first signal strength values; and
code F for enabling the electronic apparatus to determine a second deployment position of a second signal source according to the piece of plan information and the piece of updated signal strength information.

20. The non-transitory tangible machine-readable medium as claimed in claim 19, wherein the piece of plan information defines a plurality of deployable regions and the code F further comprises the following codes:
code F1 for enabling the electronic apparatus to execute the following steps for each of the deployable regions:
receiving a plurality of second signal strength values, wherein each of the second signal strength values is a signal strength value of a second signal source on one of the sub-spaces when the second signal source is disposed in the deployable region;
updating the signal strength values comprised in the piece of signal strength information according to the second signal strength values temporarily, and
calculating a statistic amount of signal strength values that are smaller than a threshold among the updated signal strength values; and
code F2 for enabling the electronic apparatus to choose the deployable region that corresponds to the smallest statistic amount as the second deployment position.

21. The non-transitory tangible machine-readable medium as claimed in claim 16, wherein the codes further comprise:
code D for enabling the electronic apparatus to detect the signal strength values in the space.

22. The non-transitory tangible machine-readable medium as claimed in claim 16, wherein the codes further comprise:
code D for enabling the electronic apparatus to sense obstacles when moving in the space so as to obtain a plurality of spatial data; and
code E for enabling the electronic apparatus to obtain the piece of plan information by processing the spatial data.
